(19) United States
(12) Patent Application Publication
(10) Pub. No.: US 2020/0064440 A1
(43) Pub. Date: Feb. 27, 2020

(54) MULTI-PATH REFLECTIONS FILTER FOR RADAR APPLICATION IN A MULTI-RADAR ENVIRONMENT

(71) Applicant: GM GLOBAL TECHNOLOGY OPERATIONS LLC, Detroit, MI (US)

(72) Inventors: Joseph Kampeas, Ramat-Gan (IL); Ofer Givati, Herzliya (IL); Igal Bilik, Rehovot (IL)

(21) Appl. No.: 16/112,134

(22) Filed: Aug. 24, 2018

(51) Int. Cl. G01S 7/02; G01S 7/292; G01S 13/93

(52) U.S. Cl. CPC G01S 7/026; G01S 7/023; G01S 13/931; G01S 7/292

(57) ABSTRACT

A vehicle, radar system for the vehicle and method for detecting an object. The radar system includes a transmitter, a receiver and a processor. The transmitter is configured to generate elliptically-polarized signals having a transmission polarization sense. The receiver configured to be receptive to signals having a reception polarization sense opposite the transmission polarization sense, thereby filtering multiply-reflected signals. The processor operates the transmitter to generate a source signal and operates the receiver to receive a reflection of the source signal from the object. The processor detects the object from the received reflection.

### INTRODUCTION

The subject disclosure relates to radar systems and their methods of operation and, in particular, to filtering signals in a radar system based on signal polarization.

A radar system operates by transmitting electromagnetic waves into a region that includes an object and receiving a reflection of these electromagnetic waves off of the object. A comparison of the transmitted waves and the reflected waves gives information regarding various radar parameters of the object, such as its range, velocity and angular location as measured by azimuth angle and/or elevation angle. In cluttered or crowded environments, a transmitted wave can reflect off of multiple surfaces, thereby reducing the quality and/or accuracy of the radar parameters. Additionally, when using a multiple radar systems simultaneously, it is possible for cross-talk to occur across the radar systems, which also reduces the quality and/or accuracy of measurements of the object. Accordingly, it is desirable to filter out signals experiencing multiple reflections or signals from multiple radar systems.

### SUMMARY

In one exemplary embodiment, a method of detecting an object is disclosed. The method includes setting a radar node to generate elliptically polarized signals having a transmission polarization sense and to be receptive to signals having a reception polarization sense opposite the first polarization sense, transmitting a source signal from the radar node, receiving, at the radar node, a reflection of the source signal from the object, wherein the reflection includes multiply-reflected signals, and filtering the multiply-reflected signals from the received reflection based on the difference between the transmission polarization sense and the reception polarization sense to detect the object.

In addition to one or more of the features described herein, the transmission polarization sense is one of a clockwise polarization and a counter-clockwise polarization, and the reception polarization sense is the other of the clockwise polarization and the counter-clockwise polarization. The generated elliptically polarized signal further includes a circularly-polarized signal. The method further includes flipping the transmission polarization sense between a first polarization sense and a second polarization sense according to a sequence and flipping the reception polarization sense synchronously with and opposite the transmission polarization sense. The sequence is a random sequence in various embodiments. The method further includes setting another radar node to generate a signal with another transmission polarization sense that flips according to another sequence uncorrelated with the sequence of the radar node. A length of the sequence and a length of the other sequence is increased reduces interference between the radar node and the other radar node.

In another exemplary embodiment, a radar system for a vehicle is disclosed. The radar system includes a transmitter, a receiver and a processor. The transmitter is configured to generate elliptically-polarized signals having a transmission polarization sense. The receiver configured to be receptive to signals having a reception polarization sense opposite the transmission polarization sense, thereby filtering multiply-reflected signals. The processor is configured to operate the transmitter to generate a source signal, receive, from the receiver, a reflection of the source signal from the object, and detect the object from the received reflection.

In addition to one or more of the features described herein, the transmission polarization sense is one of a clockwise polarization and a counter-clockwise polarization, and the reception polarization sense is the other of the clockwise polarization and the counter-clockwise polarization. The generated elliptically polarized signal further includes a circularly-polarized signal. The processor is further configured to flip the transmission polarization sense between a first polarization sense and a second polarization sense according to a first sequence and flip the reception polarization sense synchronously with and opposite the transmission polarization sense. The first sequence is a random sequence in various embodiments. The radar system further includes another transmitter configured to generate signals having another transmission polarization sense, wherein the processor is further configured to flip the transmission polarization sense of the other transmitter between the first polarization sense and the second polarization sense according to a second sequence that is uncorrelated with the first sequence. Increasing a length of the first sequence and a length of the second sequence reduces interference between the other transmitter and the transmitter.

In yet another exemplary embodiment, a vehicle is disclosed. The vehicle includes a radar node and a processor. The radar node includes a transmitter configured to generate elliptically polarized signals having a transmission polarization sense, and a receiver configured to be receptive to signals having a reception polarization sense that is opposite the transmission polarization sense, thereby filtering multiply-reflected signals. The processor is configured to operate the transmitter to generate a source signal, receive, from the receiver, a reflection of the source signal from the object, and detect the object from the received reflection.

In addition to one or more of the features described herein, the transmission polarization sense is one of a clockwise polarization and a counter-clockwise polarization, and the reception polarization sense is the other of the clockwise polarization and the counter-clockwise polarization. The generated elliptically polarized signal further comprises a circularly-polarized signal. The processor is further configured to flip the transmission polarization sense between a first polarization sense and a second polarization sense according to a first sequence and flip the reception polarization sense synchronously with the transmission polarization sense to be opposite the transmission polarization sense. The first sequence is a random sequence in various embodiments. The vehicle includes another radar node configured to generate signals having another transmission polarization sense, wherein the processor is further configured to flip the transmission polarization sense of the other radar node between the first polarization sense and the second polarization sense according to a second sequence that is uncorrelated with the first sequence.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle with an associated trajectory planning system in accordance with various embodiments;

FIG. 2 shows a plurality of radar nodes aligned in an array that can be used with the vehicle of FIG. 1;

FIG. 3 illustrates a radar node including a transmitter-receiver pair that filter out multiple reflections using circularly polarized signals; and

FIG. 4 schematically illustrates operation of a plurality of radar nodes using radar signal polarization sequences in order to filter out cross-talk between radar nodes.

### DETAILED DESCRIPTION

The following description is merely exemplary in nature and is not intended to limit the present disclosure, its application or uses. It should be understood that throughout the drawings, corresponding reference numerals indicate like or corresponding parts and features.

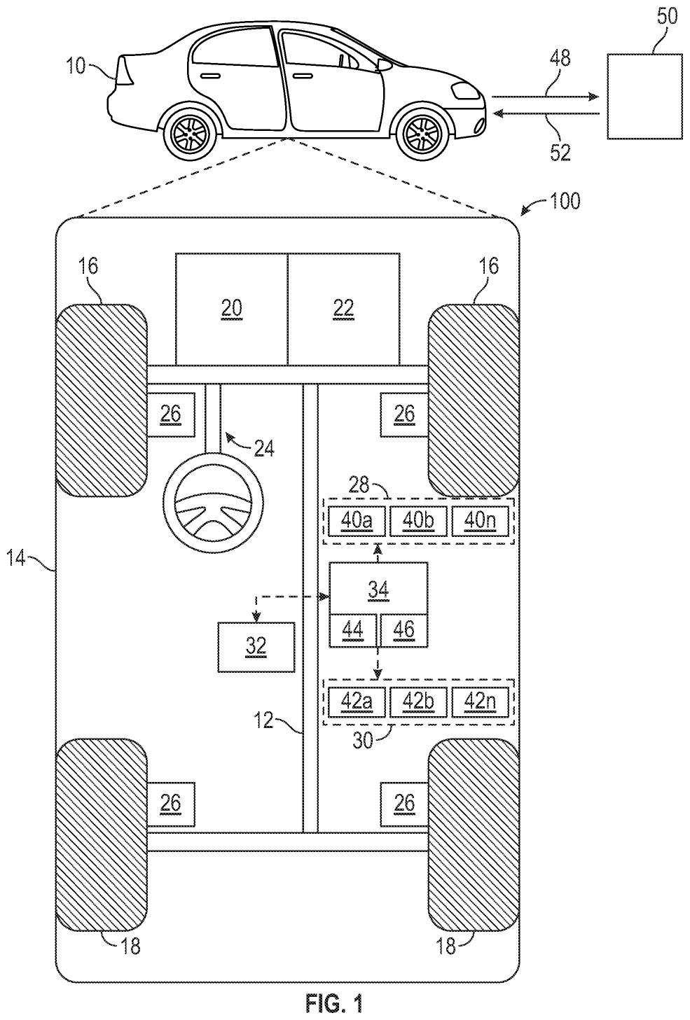

In accordance with an exemplary embodiment, FIG. 1 shows a vehicle 10 with an associated trajectory planning system depicted at 100 in accordance with various embodiments. In general, the trajectory planning system 100 determines a trajectory plan for automated driving of the vehicle 10. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16 and 18 are each rotationally coupled to the chassis 12 near a respective corner of the body 14.

In various embodiments, the vehicle 10 is an autonomous vehicle and the trajectory planning system 100 is incorporated therein. The vehicle 10 can, for example, be automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the vehicle 10 generally includes a propulsion system 20, a transmission system 22, a steering system 24, a brake system 26, a sensor system 28, an actuator system 30, at least one data storage device 32, and at least one controller 34. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16 and 18. The brake system 26 may, in various embodiments, include friction brakes, brake by wire, a regenerative braking system such as an electric machine, and/or other appropriate braking systems. The steering system 24 influences a position of the vehicle wheels 16 and 18. While depicted as including a steering wheel for illustrative purposes, in some embodiments contemplated within the scope of the present disclosure, the steering system 24 may not include a steering wheel.

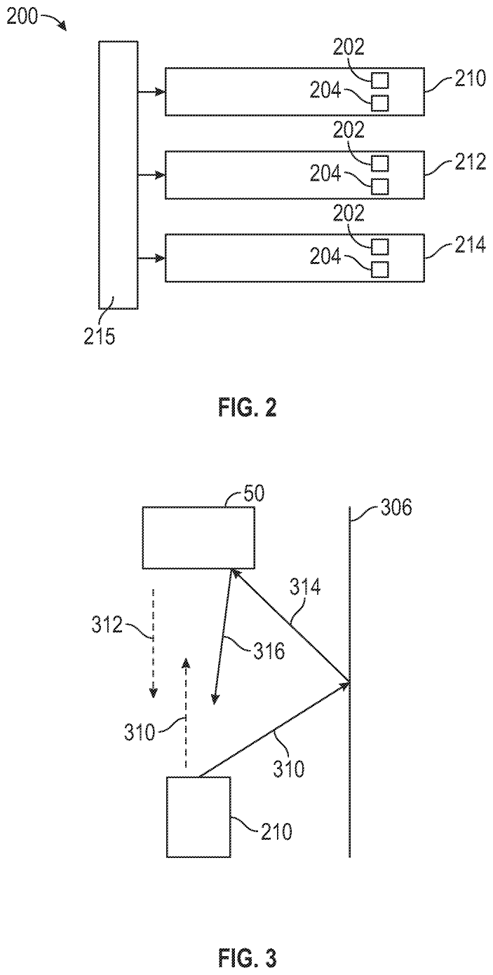

The sensor system 28 includes one or more sensing devices 40a-40n that sense observable conditions of the exterior environment and/or the interior environment of the vehicle 10. The sensing devices 40a-40n can include, but are not limited to, radars, lidars, global positioning systems, optical cameras, thermal cameras, ultrasonic sensors, and/or other sensors. In various embodiments, the vehicle 10 includes a radar system 200, FIG. 2. The radar system 200 includes one or more radar nodes located at various locations along the vehicle 10. In operation, a radar node sends out electromagnetic pulses 48 that are reflected back at the vehicle 10 by the object 50 in the form of reflected pulses 52. The reflected pulses 52 are received at the radar node in order to determine parameters such as range, angular location and Doppler frequency (velocity) of the object 50. Multiple signal reflections or cross-talk from other radars can make it difficult to determine these parameters.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as ventilation, music, lighting, etc. (not numbered).

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

The trajectory planning system 100 navigates the autonomous vehicle 10 based on a determination of objects and/their locations within the environment of the vehicle. In various embodiments the controller 34 performs calculations to determine the presence and/or location of an object 50 in the vehicle's environment from the reflections 52 received at the road nodes. Upon determining various parameters of the object, such as range, azimuth, elevation, velocity, etc., from the plurality of detections, the controller 34 can operate the one or more actuator devices 42a-42n, the propulsion system 20, transmission system 22, steering system 24 and/or brake 26 in order to navigate the vehicle 10 with respect to the object 50. In various embodiments, the controller 34 navigates the vehicle 10 so as to avoid contact with the object 50.

FIG. 2 shows a plurality of radar nodes (210, 212, 214) aligned in an array 200 that can be used with the vehicle 10 of FIG. 1. The array 200 can be a multi-input and multi-output (MIMO) array in various embodiments. Although only three radar nodes 210, 212, 214 are shown in FIG. 2, it is to be understood that any number of radar nodes can be used. Each radar node (210, 212, 214) includes a transmitter Tx 202 and a receiver Rx 204 forming a transmitter-receiver pair. Each receiver 204 of a radar node (210, 212, 214) is coordinated with its paired transmitter 202. In particular, the receiver 204 has a reception polarization that is receptive to reflections from an object of a signal generated by its paired transmitter 202 with a transmission polarization. Each radar node (210, 212, 214) is in communication with a processor 215 that can operate the transmitter-receiver pairs according to the methods disclosed herein.

In various embodiments, the transmitter 202 generates signals having a circular or elliptical polarization. Such signals have a polarization sense indicating the direction of rotation of the polarization vector. The polarization sense can be either a clockwise rotation or a counter-clockwise rotation which are labelled either “right” or “left”. When a transmitted signal having a selected circularly polarization sense is reflected off of an object that is a conductor, the reflected signal has a polarization sense opposite to the polarization sense of the transmitted signal. For example, when the transmitted signal is RCP (right circularly polarized), the reflected signal will be LCP (left circularly polarized) and when the transmitted signal is LCP, the reflected signal will be RCP. The general case of a circularly polarized wave is an elliptically polarized wave, where the circularly polarized wave is a particular case, having the minor and major axes equal in magnitude. Upon reflection of an elliptically polarized wave, off of a target, the polarization sense changes from right-handed (RH) to left-handed (LH) and vice versa. Thus, the receiver of a radar node is synchronized with its paired transmitter to be receptive to signals having polarization senses opposite that of the signals generated by its paired transmitter. The transmitter can change its transmission polarization sense, with the receiver simultaneously changing its reception polarization sense to maintain the reception polarization sense opposite to the transmission polarization sense.

FIG. 3 illustrates a radar node (e.g., radar node 210) including a transmitter-receiver pair that operates using at least one of RCP or LCP signals in order to filter out multiple reflections. The use of transmitter-receiver pairs with opposing polarization senses filters out multiply-reflected signals. For illustrative purposes, the radar 210 generates a transmitted signal 310 that is LCP. Therefore, the receiver of radar 210 is configured to be receptive to RCP signals. Along one direction, the transmitted signal 310 reflects directly off of object 50 to generate a reflected signal 312 that is RCP. Along another direction, the transmitted signal 310 reflects of both boundary 306 and object 50. Upon reflecting off of boundary 306, the reflected signal 314 is RCP. When signal 314 is incident on object 50, the resulting (doubly reflected) signal 316 is now LCP. Thus, the receiver of node 210 is receptive to the directly reflected signal 312 while being transparent to the doubly-reflected signal 316. By having the reception polarization sense opposite the transmission polarization sense, the receiver is transparent to the twice-reflected RCP signal as well as to any transmitted signal that has undergone an even number of reflections before returning to the receiver. Although a transmitted signal that experiences an odd number of reflections before impinging on a receiver is observed by the receiver, as the number of reflections increases, the amplitude of the signal is reduced due to path-loss.

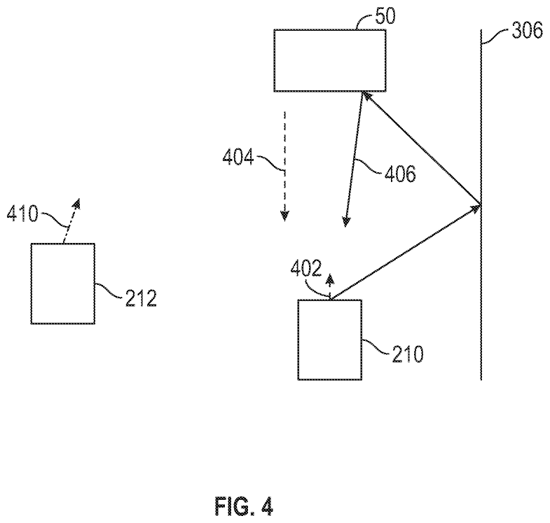

FIG. 4 schematically illustrates operation of a plurality of radar nodes using radar signal polarization sense sequences in order to filter out cross-talk between radar nodes. The filtering of signals from other radar nodes occurs by flipping the transmission polarization sense of the transmitter and the reception polarization sense of the receiver according to a sequence, keeping the reception polarization sense opposite the transmission polarization sense. Each radar node changes its polarization senses according to a polarization sequence that is individual to the radar node. In various embodiments, one sequence can be a random sequence or more than one sequence can be a random sequence. In FIG. 4, the first radar node 210 operates using a first polarization sense sequence 402 and a second radar node 212 uses a second polarization sense sequence 410. The first polarization sense sequence 402 is different than the second polarization sense sequence 410.

For illustrative purposes, the first transmitter 210 transmits the first polarization sense sequence 402, labelled “ . . . LLRRL . . . ”. A direct reflection of the first sequence from object 50 produces the inverse 404 (i.e., “ . . . RRLLR . . . ”) of the first sequence. Since the reception polarization sense of the receiver of the first radar node 210 is changed in lock-step with the transmission polarization sense of the first radar node 210, the inverse 404 of the first sequence is read at the first radar node 210. A multiply-reflected signal that includes a reflection of the first polarization sense sequence 402 off of both boundary 306 and object 50 produces a copy 406 of the first sequence at the first radar node 210. The first radar node 210 is not receptive to the copy 406 of first sequence and thus is transparent to this multiply-reflected signal.

Meanwhile, second radar 420 transmits a second polarization sense sequence (e.g., “ . . . RLRLR . . . ”) 410 which different from the first polarization sense sequence 402. Clearly the longer the first polarization sense sequence 402 and second polarization sense sequence 410, the less correlation between the signal sequences and their respective polarization senses. Thus, the longer the first and sequences become, the lower the probability that the second sequence is read at the first radar node 210 and the lower the probability that the first sequence is read at the second radar node 212. This lack of correlation between signals can be maintained when additional radar nodes are used by having each additional radar node pair transmitting its own polarization sense sequence.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A method of detecting an object, comprising:
setting a radar node to generate elliptically polarized signals having a transmission polarization sense and to be receptive to signals having a reception polarization sense opposite the first polarization sense;
transmitting a source signal from the radar node;
receiving, at the radar node, a reflection of the source signal from the object, wherein the reflection includes multiply-reflected signals; and
filtering the multiply-reflected signals from the received reflection based on the difference between the transmission polarization sense and the reception polarization sense to detect the object.

2. The method of claim 1, wherein the transmission polarization sense is one of a clockwise polarization and a counter-clockwise polarization, and the reception polarization sense is the other of the clockwise polarization and the counter-clockwise polarization.

3. The method of claim 1, wherein the generated elliptically polarized signal further comprises a circularly-polarized signal.

4. The method of claim 1, further comprising flipping the transmission polarization sense between a first polarization sense and a second polarization sense according to a sequence and flipping the reception polarization sense synchronously with and opposite the transmission polarization sense.

5. The method of claim 4, wherein the sequence is a random sequence.

6. The method of claim 4, further comprising setting another radar node to generate a signal with another transmission polarization sense that flips according to another sequence uncorrelated with the sequence of the radar node.

7. The method of claim 6, further comprising increasing a length of the sequence and a length of the other sequence to reduce interference between the radar node and the other radar node.

8. A radar system for a vehicle, comprising:
a transmitter configured to generate elliptically-polarized signals having a transmission polarization sense;
a receiver configured to be receptive to signals having a reception polarization sense opposite the transmission polarization sense, thereby filtering multiply-reflected signals; and
a processor configured to:
operate the transmitter to generate a source signal;
receive, from the receiver, a reflection of the source signal from the object; and
detect the object from the received reflection.

9. The radar system of claim 8, wherein the transmission polarization sense is one of a clockwise polarization and a counter-clockwise polarization, and the reception polarization sense is the other of the clockwise polarization and the counter-clockwise polarization.

10. The radar system of claim 8, wherein the generated elliptically polarized signal further comprises a circularly-polarized signal.

11. The radar system of claim 8, wherein the processor is further configured to flip the transmission polarization sense between a first polarization sense and a second polarization sense according to a first sequence and flip the reception polarization sense synchronously with and opposite the transmission polarization sense.

12. The radar system of claim 11, wherein the first sequence is a random sequence.

13. The radar system of claim 11, further comprising another transmitter configured to generate signals having another transmission polarization sense, wherein the processor is further configured to flip the transmission polarization sense of the other transmitter between the first polarization sense and the second polarization sense according to a second sequence that is uncorrelated with the first sequence.

14. The radar system of claim 12, further comprising increasing a length of the first sequence and a length of the second sequence to reduce interference between the other transmitter and the transmitter.

15. A vehicle, comprising:
a radar node including:
a transmitter configured to generate elliptically polarized signals having a transmission polarization sense; and
a receiver configured to be receptive to signals having a reception polarization sense that is opposite the transmission polarization sense, thereby filtering multiply-reflected signals; and
a processor configured to:
operate the transmitter to generate a source signal;
receive, from the receiver, a reflection of the source signal from the object; and
detect the object from the received reflection.

16. The vehicle of claim 15, wherein the transmission polarization sense is one of a clockwise polarization and a counter-clockwise polarization, and the reception polarization sense is the other of the clockwise polarization and the counter-clockwise polarization.

17. The vehicle of claim 15, wherein the generated elliptically polarized signal further comprises a circularly-polarized signal.

18. The vehicle of claim 15, wherein the processor is further configured to flip the transmission polarization sense between a first polarization sense and a second polarization sense according to a first sequence and flip the reception polarization sense synchronously with the transmission polarization sense to be opposite the transmission polarization sense.

19. The vehicle of claim 18, wherein the first sequence is a random sequence.

20. The vehicle of claim 18, further comprising another radar node configured to generate signals having another transmission polarization sense, wherein the processor is further configured to flip the transmission polarization sense of the other radar node between the first polarization sense and the second polarization sense according to a second sequence that is uncorrelated with the first sequence.
